(19) United States
(12) Patent Application Publication
(10) Pub. No.: US 2026/0220585 A1
(43) Pub. Date: Jul. 30, 2026

(54) DATA PROCESSING METHOD AND APPARATUS, DEVICE, AND STORAGE MEDIUM

(71) Applicant: Beijing Zitiao Network Technology Co., Ltd., Beijing (CN)

(72) Inventors: Yaodong ZHENG, Beijing (CN); Shaoqiang HUANG, Beijing (CN)

(21) Appl. No.: 19/144,444

(22) PCT Filed: Feb. 2, 2024
(86) PCT No.: PCT/CN2024/075456

§ 371 Date: Jun. 27, 2025

(30) Foreign Application Priority Data
Feb. 2, 2023 (CN) 202310118084.8

(51) Int. Cl. G06Q 10/067; G06F 16/28

(52) U.S. Cl. CPC G06Q 10/0672; G06F 16/284; G06F 16/289

(57) ABSTRACT

A data processing method and apparatus, a device, and a storage medium. The method comprises: receiving a target service object topological map configured by a user, wherein the target service object topological map comprises a plurality of target service objects at different levels; determining target instance data relationship information corresponding to the target service object topological map, wherein the target instance data relationship information comprises target instance data corresponding to the target service object topological map and an association relationship between the target instance data; generating an instance data topological map on the basis of the target instance data relationship information; and displaying the instance data topological map.

### CROSS-REFERENCE TO RELATED APPLICATIONS

The present application is a U.S. national stage application of International Patent Application No. PCT/CN2024/075456, filed on Feb. 2, 2024, and entitled “DATA PROCESSING METHOD AND APPARATUS, DEVICE, AND STORAGE MEDIUM”, which claims priority to Chinese Application No. 202310118084.8, filed on Feb. 2, 2023, and entitled “DATA PROCESSING METHOD AND APPARATUS, DEVICE, AND STORAGE MEDIUM”, the disclosures of which are incorporated herein by reference in their entireties.

### TECHNICAL FIELD

Embodiments of the present disclosure relate to the technical field of data processing, and in particular, to a data processing method and apparatus, a device, and a storage medium.

### BACKGROUND

During development and management of a software project, a large amount of business data related to the software project is often generated. If the business data is managed in an efficient manner, the efficiency of development and management of the software project can be greatly improved. Therefore, effective management of the business data is particularly important.

Currently, the use of tree view to manage business data is widely adopted.

### SUMMARY

Embodiments of the present disclosure provide a data processing method and apparatus, a device, and a storage medium, which can improve the flexibility in data presentation by presenting data through a user-configured topology diagram.

According to a first aspect, an embodiment of the present disclosure provides a data processing method. The method includes:
receiving a target business object topology diagram configured by a user, where the target business object topology diagram includes target business objects at a plurality of levels;
determining target instance data relationship information corresponding to the target business object topology diagram, where the target instance data relationship information includes target instance data corresponding to the target business object topology diagram and an association relationship between the target instance data;
generating an instance data topology diagram based on the target instance data relationship information; and
displaying the instance data topology diagram.

According to a second aspect, an embodiment of the present disclosure further provides a data processing apparatus. The apparatus includes:
a target business object topology diagram configuration module configured to receive a target business object topology diagram configured by a user, where the target business object topology diagram includes target business objects at a plurality of levels;
a target instance data relationship information determination module configured to determine target instance data relationship information corresponding to the target business object topology diagram, where the target instance data relationship information includes target instance data corresponding to the target business object topology diagram and an association relationship between the target instance data;
an instance data topology diagram generation module configured to generate an instance data topology diagram based on the target instance data relationship information; and
a display module configured to display the instance data topology diagram.

According to a third aspect, an embodiment of the present disclosure further provides an electronic device. The electronic device includes:
one or more processors; and
a storage apparatus configured to store one or more programs, where
the one or more programs, when executed by the one or more processors, cause the one or more processors to implement the data processing method according to the embodiments of the present disclosure.

According to a fourth aspect, an embodiment of the present disclosure further provides a storage medium including computer-executable instructions, where the computer-executable instructions are configured to, when executed by a computer processor, cause the computer processor to perform the data processing method according to the embodiments of the present disclosure.

### BRIEF DESCRIPTION OF THE DRAWINGS

The foregoing and other features, advantages, and aspects of embodiments of the present disclosure become more apparent with reference to the following specific implementations and in conjunction with the accompanying drawings. Throughout the drawings, the same or similar reference numerals denote the same or similar elements. It should be understood that the accompanying drawings are schematic and that parts and elements are not necessarily drawn to scale.

FIG. 1 is a schematic flowchart of a data processing method according to an embodiment of the present disclosure;

FIG. 2a is an example diagram of an original business object topology diagram according to an embodiment of the present disclosure;

FIG. 2b is an example diagram of a configuration page according to an embodiment of the present disclosure;

FIG. 2c is a schematic diagram of a structure of a target business object topology diagram according to an embodiment of the present disclosure;

FIG. 3a is an example diagram of an instance data topology diagram according to an embodiment of the present disclosure;

FIG. 3b is an example diagram of an instance data topology diagram according to an embodiment of the present disclosure;

FIG. 4 is an example diagram of pruning an instance data topology diagram according to an embodiment of the present disclosure;

FIG. 5 is an example diagram of presenting instance data according to an embodiment of the present disclosure;

FIG. 6 is a schematic diagram of a structure of a data processing apparatus according to an embodiment of the present disclosure; and

FIG. 7 is a schematic diagram of a structure of an electronic device according to an embodiment of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

It can be understood that before the use of the technical solutions disclosed in the embodiments of the present disclosure, the user shall be informed of the type, range of use, use scenarios, etc. of personal information involved in the present disclosure in an appropriate manner in accordance with the relevant laws and regulations, and the authorization of the user shall be obtained.

For example, in response to reception of an active request from the user, prompt information is sent to the user to clearly inform the user that a requested operation will require access to and use of the personal information of the user. As such, the user can autonomously choose, based on the prompt information, whether to provide the personal information to software or hardware, such as an electronic device, an application, a server, or a storage medium, that performs operations in the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

It can be understood that the data involved in the technical solutions (including, but not limited to, the data itself and the access to or use of the data) shall comply with the requirements of corresponding laws, regulations, and relevant provisions.

Existing products have rudimentary tree view functions, for example: only predefined types and hierarchies are available and data can only be expanded level by level, making it impossible to perform flexible tree configuration and tree result presentation.

The embodiments of the present disclosure provide a data processing method and apparatus, a device, and a storage medium. The method includes: receiving a target business object topology diagram configured by a user, where the target business object topology diagram includes target business objects at a plurality of levels; determining target instance data relationship information corresponding to the target business object topology diagram, where the target instance data relationship information includes target instance data corresponding to the target business object topology diagram and an association relationship between the target instance data; generating an instance data topology diagram based on the target instance data relationship information; and displaying the instance data topology diagram. According to the data processing method disclosed in the embodiments of the present disclosure, the corresponding instance data topology diagram is generated based on the target business object topology diagram configured by the user, and is then displayed, such that only instance data required by the user is presented. This can not only significantly reduce the amount of data to be processed, but can also increase the diversity and flexibility in data presentation.

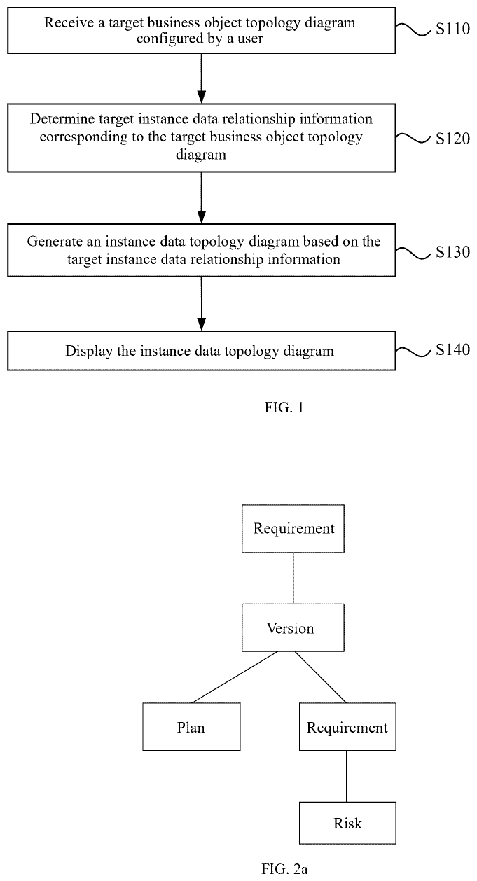

FIG. 1 is a schematic flowchart of a data processing method according to an embodiment of the present disclosure. This embodiment of the present disclosure is applicable to the case of processing data. The method can be performed by a data processing apparatus. The apparatus may be implemented in the form of software and/or hardware. Optionally, the apparatus may be implemented by an electronic device, and the electronic device may be a mobile terminal, a personal computer (PC), a server, etc.

As shown in FIG. 1, the method includes the following steps.

S110: Receive a target business object topology diagram configured by a user.

The target business object topology diagram includes target business objects at a plurality of levels. The target business object may be a business object that is selected by the user from original business objects. The original business objects may be understood as business objects preset for a business project or business objects configured by the user themselves according to business needs (i.e., customized original business objects). The business objects may also be referred to as work item types. In this embodiment, the configuration of the original business objects is not limited. For example, for a business in a system development process, the preset original business objects may include: “Requirement”, “Defect”, “Task,” “Plan”, “Risk”, etc. The target business object topology diagram may be understood as a topology diagram composed of a plurality of target business objects, including a plurality of levels, with at least one target business object included in each level. In this embodiment, the topology diagram may be a tree diagram, including: a root node, an intermediate node, and a leaf node.

In some embodiments, the process of receiving the target business object topology diagram configured by the user may involve: jumping to a configuration page corresponding to a selected target business object based on a configuration operation triggered by the user on the selected target business object; and receiving a selection operation performed by the user on the configuration page for sub-target business objects to which the selected target business object expands on at least one level, to obtain a target business object topology diagram with the selected target business object as a root node.

The configuration operation triggered by the user on the selected target business object may be understood as a configuration operation triggered on a view of the selected target business object. The sub-target business objects to which the selected target business object expands on at least one level may be understood as at least one level of expansion of the selected target business object in an original business object topology tree.

The configuration page may include a resource panel and a configuration panel. The resource panel and the configuration panel are in different areas. The configuration panel is used to receive a selection operation performed by the user for sub-target business objects to which the selected target business object expands on at least one level, and the resource panel is used to display the target business object selected by the user in the configuration panel and attribute information of the target business object. In the resource panel, the target business objects are presented as a list according to an order of their hierarchical relationships. In this embodiment, the attribute information is to be dragged and dropped for selection by the user.

In this embodiment, when the user needs to configure the target business object topology diagram, a configuration button in the view of the selected target business object is first clicked on to enter the configuration page, and the selected target business object is presented in the resource panel and the configuration panel. In the case where there is a sub-target business object for the selected target business object, a drop-down button is set on the target business object, and by clicking on the drop-down button, the sub-target business object is displayed for the target business object, such that the user can select one or more sub-target business objects. In the case where there is also a sub-target business object for the selected sub-target business object, a drop-down button is also configured for the user to drop-down select, and so on, until the leaf nodes are selected, such that a plurality of target business objects having hierarchical relationships therebetween are selected. All the selected target business objects form the target business object topology diagram.

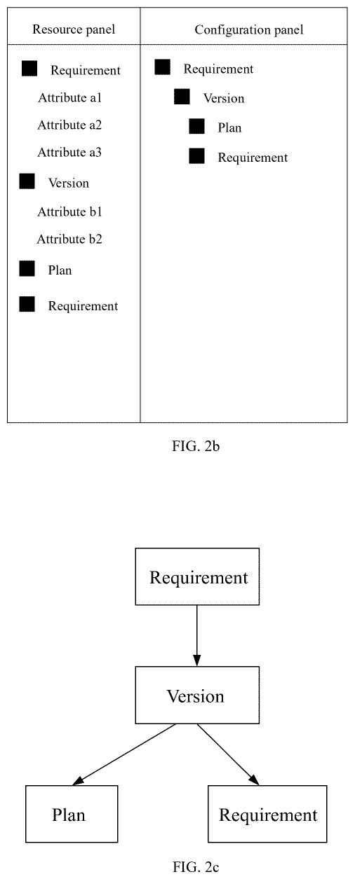

For example, FIG. 2a is an example diagram of an original business object topology diagram in this embodiment. As shown in FIG. 2a, original business objects include: “Requirement”, “Version”, “Defect”, “Plan”, and “Risk”, with “Requirement” at the first level, “Version” at the second level, both “Plan” and the other “Requirement” at the third level, and “Risk” at the fourth level. “Requirement” is the root node, “Version” is a child node of “Requirement”, both “Plan” and the other “Requirement” are child nodes of “Version”, and “Risk” is a child node of “Requirement”. FIG. 2b is an example diagram of a configuration page in this embodiment. As shown in FIG. 2b, in the left area is the resource panel in which the selected target business objects are displayed as a list. In the configuration panel, the configuration operation triggered by the user can be received. As shown in FIG. 2b, in the resource panel, attribute information may also be presented for each target business object, where “Requirement” includes an attribute a1, an attribute a2, and an attribute a3; “Version” includes an attribute b1 and an attribute b2, and “Plan”, “Defect”, and “Risk” have their attribute information not expanded for display. In this embodiment, in the resource panel, an expand/collapse button is set on each original business object, and the user can expand or collapse the attribute information of the original business object by clicking on the expand/collapse button. As shown in FIG. 2b, if the target business object “Requirement” is selected in the view, and “Requirement” includes a child node “Version”, a drop-down button is set on “Requirement”, and the user clicks on the drop-down button and “Version” is then displayed. When the user selects “Version”, a drop-down button is set for “Version” as “Version” has child nodes. In this way, in the configuration panel, the target business objects selected by the user include: two “Requirement”, one “Version”, and one “Plan”, with one “Requirement” at the first level and the other “Requirement” at the third level, “Version” at the second level, and “Plan” at the third level. FIG. 2c is a schematic diagram of a structure of a target business object topology diagram in this embodiment. As shown in FIG. 2c, the topology diagram is constructed based on the configuration of the user in FIG. 2b. As shown in FIG. 2c, one “Requirement” is the root node, “Version” is the child node of “Requirement”, and the other “Requirement” and “Plan” are both the child nodes of “Version”.

In this embodiment, the user can configure the target business object topology diagram according to business requirements at a front-end interface, and can freely adjust the hierarchy of business objects, to improve the flexibility in configuration.

S120: Determine target instance data relationship information corresponding to the target business object topology diagram.

The target instance data relationship information includes target instance data corresponding to the target business object topology diagram and an association relationship between the target instance data. The target instance data may be understood as the specific data of the target business object. If the target business object may be understood as a variable, the target instance data may be understood as the specific value of the variable. In this embodiment, the target instance data relationship information includes: an instance data identity document (ID), an association relationship ID, and an instance data ID that establishes the association relationship with the target instance data. For example, relationship information of “Instance data 1” is as follows: “Instance data 1”: [{Association relationship ID: “123”, Instance data ID: [“A”, “B”]}, {Association relationship ID: “456”, Instance data ID: [“C”, “D”]}]. The above instance may be understood as: “Instance data 1” has the association relationship “123” with “Instance data A”, “Instance data 1” has the association relationship “123” with “Instance data B”, “Instance data 1” has the association relationship “456” with “Instance data C”, and “Instance data 1” has the association relationship “456” with “Instance data D”.

In this embodiment, the target instance data relationship information corresponding to the target business object topology diagram may be determined by: obtaining original instance data relationship information corresponding to an original business object set; and filtering the original instance data relationship information based on the target business object topology diagram, to obtain the target instance data relationship information.

The original business object set may include a plurality of original business objects, and the plurality of original business objects may form a topology diagram, that is, there is a hierarchical relationship between the original business objects. The original instance data relationship information may be information pre-stored in a database, and is full instance data relationship information corresponding to the original business object set. In some embodiments, the process of filtering the original instance data relationship information based on the target business object topology diagram may be: first extracting, based on identity information of each target business object, instance data corresponding to each target business object, performing further filtering on the extracted instance data based on an association relationship corresponding to the extracted instance data and a hierarchical relationship in the target business object topology diagram, and determining relationship information corresponding to the instance data obtained by the filtering as the target instance data relationship information.

In some embodiments, the original instance data relationship information may be filtered, based on the target business object topology diagram, to obtain the target instance data relationship information by: traversing the target business object topology diagram to obtain a plurality of pieces of candidate instance data corresponding to a target business object that is traversed; obtaining target instance data of a parent node of the traversed target business object; filtering the plurality of pieces of candidate instance data to obtain candidate instance data that has an association relationship with the target instance data of the parent node, and determining the obtained candidate instance data as target instance data of the traversed target business object; and recording an association relationship corresponding to the target instance data and hierarchy information of the target instance data.

The hierarchy information is information about a level at which a target business object corresponding to the target instance data is located. The target business object topology diagram may be traversed by: performing traversal from the root node until all the target business objects in the target business object topology diagram have been traversed.

In this embodiment, the original instance data relationship information further includes identity information of a business object corresponding to current instance data. The plurality of pieces of candidate instance data corresponding to the target business object that is traversed may be obtained by: extracting, based on identity information of the traversed target business object and from the original instance data relationship information, the plurality of pieces of candidate instance data corresponding to the target business object. In the case where the traversed target business object is the root node, the extracted candidate instance data is used as the target instance data. In the case where the traversed target business object is not the root node, the target instance data of the parent node of the traversed target business object is obtained, and the plurality of pieces of candidate instance data are filtered to obtain the candidate instance data that has the association relationship with the target instance data of the parent node, and the obtained candidate instance data is then determined as the target instance data of the traversed target business object.

Exemplarily, for the target business object topology diagram in FIG. 2c, the target business object topology diagram is traversed starting from the root node. First, the root node “Requirement” is traversed to obtain candidate instance data thereof based on identity information of “Requirement”, which is instance data A1, instance data A2, instance data A3, and instance data A4, respectively, where since “Requirement” is the root node, the four pieces of instance data are all used as target instance data of “Requirement”, and the hierarchy information of the four pieces of instance data is recorded as the first level; next, “Version” is traversed to obtain candidate instance data thereof based on identity information of “Version”, which is instance data B1, instance data B2, and instance data B3, respectively, where if the instance data B1 has an association relationship with the instance data A1 and the instance data A3, and the instance data B3 has an association relationship with the instance data A4, target instance data of “Version” is the instance data B1 and the instance data B3, and the hierarchy information of the two pieces of instance data is recorded as the second level; then, “Plan” is traversed to obtain candidate instance data thereof based on identity information of “Plan”, which is instance data C1, instance data C2, and instance data C3, respectively, where if the instance data C1 has an association relationship with the instance data B1, target instance data of “Plan” is the instance data C1, and the hierarchy information of this piece of instance data is recorded as the third level; and further, “Requirement” is traversed to obtain candidate instance data thereof based on identity information of “Requirement”, which candidate instance data is instance data A1, instance data A2, instance data A3, and instance data A4, respectively, where if both the instance data A2 and the instance data A3 have an association relationship with the instance data B1, target instance data of “Requirement” is the instance data A2 and the instance data A3, and the hierarchy information of the two pieces of instance data is recorded as the third level. In this embodiment, the hierarchy information of each instance data is recorded, which facilitates subsequent accurate generation of the instance data topology diagram.

In this embodiment, the original instance data relationship information is filtered based on the association relationship and the target business object topology diagram, which can improve the efficiency and accuracy in obtaining the relationship information.

Optionally, after the filtering the plurality of pieces of candidate instance data to obtain candidate instance data that has an association relationship with the target instance data of the parent node, the method further includes the following steps: obtaining a filtering condition that is configured by the user for the traversed target business object; and performing further filtering on the target instance data based on the filtering condition.

The filtering condition is set by the user for the target business object according to business requirements. Performing further filtering on the target instance data based on the filtering condition may be understood as retaining target instance data that meets the filtering condition. In this embodiment, when the user sets the filtering condition, a jump is made to a filtering condition configuration page on which each target business object is set with a filter box, and the user triggers the filter box by clicking thereon to display a filtering range for the target business object, and selects a sub-range from the filtering range to obtain the filtering condition for the target business object. Exemplarily, if a filtering condition for a target business object is that the target business object has a value of P0 for its instance data, only instance data with the value of P0 is included for the target business object. In this embodiment, the further filtering is performed on the target instance data based on the filtering condition configured by the user, which can reduce the amount of data, thereby improving the efficiency of data processing.

S130: Generate an instance data topology diagram based on the target instance data relationship information.

The target instance data relationship information includes the association relationship corresponding to each target instance data and hierarchy information of the target instance data. Therefore, the instance data topology diagram can be generated based on the target instance data relationship information.

In some embodiments, the instance data topology diagram may be generated based on the target instance data relationship information by: grouping the target instance data based on the association relationship; sorting the grouped target instance data according to the hierarchy information; and topologically connecting the sorted target instance data to generate an instance data topology diagram corresponding to each group.

The process of grouping the target instance data based on the association relationship may involve: obtaining target instance data that can form an association relationship chain, and dividing, into one group, target instance data that are on the same association relationship chain, where the association relationship chain has branches. Based on the above-described embodiment, the target instance data corresponding to the target business object topology diagram in FIG. 2c includes: instance data A1, instance data A2, instance data A3, instance data A4, instance data B1, instance data B3, instance data C1, instance data A2, and instance data A3, which form two association relationship chains including: instance data A1-instance data B1-(instance data C1 and instance data A2); and instance data A3-instance data B1-(instance data C1 and instance data A3), that is, the target instance data can be divided into two groups.

The grouped target instance data may be sorted according to the hierarchy information by: for each group of target instance data, sorting the data according to a descending order of hierarchy. In other words, a higher hierarchy level indicates a higher ranking, and the target instance data at the same hierarchy level is sorted with the same rank. Based on the above-described embodiment, sorting results for the two groups of target instance data, namely, instance data A1-instance data B1-(instance data C1 and instance data A2) and instance data A3-instance data B1-(instance data C1 and instance data A3) are: \textcircled{1} instance data A1, \textcircled{2} instance data B1, and \textcircled{3} instance data C1 and instance data A2; and \textcircled{1} instance data A3, \textcircled{2} instance data B1, and \textcircled{3} instance data C1 and instance data A3.

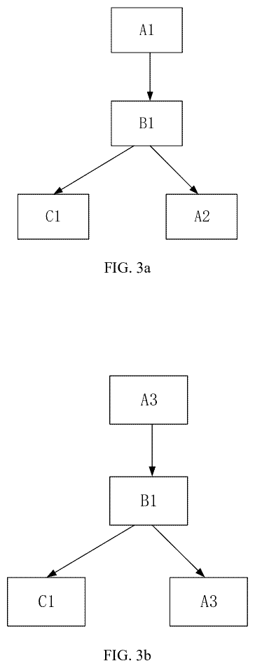

In some embodiments, the process of topologically connecting the sorted target instance data may involve: connecting sequentially adjacent target instance data with the association relationships to obtain an instance data topology diagram corresponding to each group. Based on that above-described embodiment, if the target instance data is divided into two groups, two instance data topology diagrams can be obtained. Exemplarily, FIG. 3a and FIG. 3b are example diagrams of an instance data topology diagram in this embodiment. As shown in FIG. 3a, the instance data topology diagram is obtained by topologically connecting the group of target instance data, namely, \textcircled{1} instance data A1, \textcircled{2} instance data B1, and \textcircled{3} instance data C1 and instance data A2. As shown in FIG. 3b, the instance data topology diagram is obtained by topologically connecting the group of target instance data, namely, \textcircled{1} instance data A3, \textcircled{2} instance data B1, and \textcircled{3} instance data C1 and instance data A3.

In this embodiment, the target instance data is grouped first, and then sorted and finally topologically connected, which can improve the accuracy of the generated instance data topology diagram.

Optionally, after the generating an instance data topology diagram based on the target instance data relationship information, the method further includes the following steps: obtaining permission information of the user; and pruning the instance data topology diagram based on the permission information, to obtain a final instance data topology diagram.

The permission information of the user may be preset based on the user identity, and the permission information includes a range of instance data that the user can access.

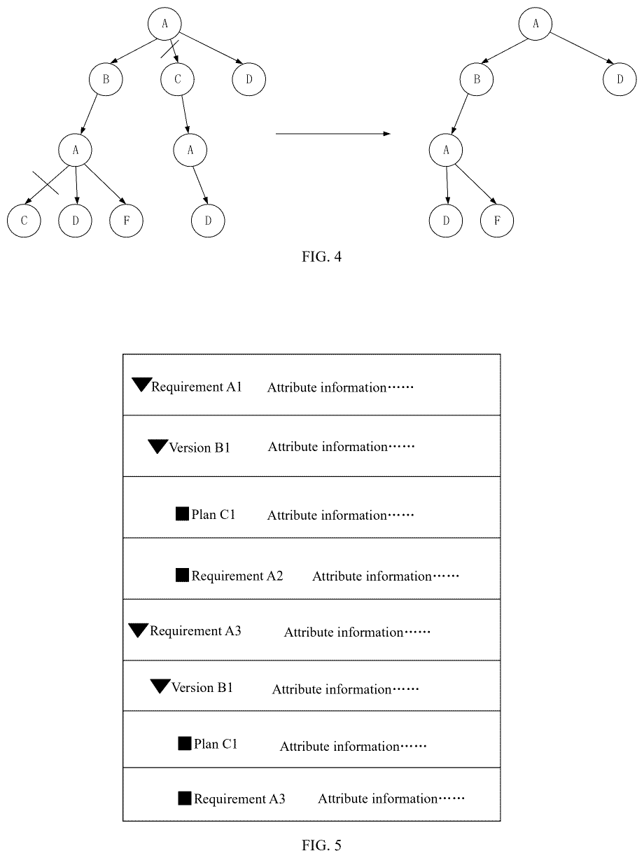

In some embodiments, the process of pruning the instance data topology diagram based on the permission information may involve: first determining, based on the permission information, target instance data for which the user has no access right, and then pruning, from the instance data topology diagram, an instance data topology sub-diagram with the target instance data as the root node, to obtain the final instance data topology diagram. Exemplarily, FIG. 4 is an example diagram of pruning an instance data topology diagram in this embodiment. As shown in FIG. 4, the left side shows the generation of the instance data topology diagram based on target instance data relationship information, in which the user has no access right for instance data C, and therefore, an instance data topology sub-diagram with the instance data C as the root node needs to be pruned from the instance data topology diagram, to obtain a final instance data topology diagram on the right side.

In this embodiment, the instance data topology diagram is pruned based on the permission information, which cannot only further reduce the amount of data, but can also improve the security of data.

S140: Display the instance data topology diagram.

The instance data is composed of an instance data identity and attribute information of the instance data, and displaying the instance data topology diagram may be understood as: displaying the determined target instance data as a topology diagram.

In some embodiments, the instance data topology diagram may be displayed by: obtaining instance data and hierarchy information of each node in the instance data topology diagram; and displaying the instance data of each node as a list based on the hierarchy information.

The list may be understood as that one piece of instance data occupies one row or one piece of instance data occupies one column, and the instance data identity and the attribute information of the instance data are displayed in the corresponding column or row in a certain order. In this embodiment, the instance data identity may be placed first. In order for the displayed data to match the topology diagram, different hierarchies correspond to different indentation with an inverse relationship between the indentation and the hierarchy information, that is, a higher hierarchy indicates a smaller indentation, and a lower hierarchy indicates a larger indentation. In this embodiment, the root node is at the highest level.

In this embodiment, the process of displaying the instance data of each node as a list based on the hierarchy information may involve: determining, based on the hierarchy information, location information of a cell in which the instance data of each node is located; and displaying the instance data of each node as a list based on the location information.

The cell is a column cell or a row cell, and the location information includes indentation information.

In some embodiments, when the cell is the row cell, the indentation information indicates a horizontal indent size and a row height needs to be configured for the row cell. The process of determining, based on the hierarchy information, location information of a cell in which the instance data of each node is located may involve: first determining the rank of the instance data of the node based on the hierarchy information, determining a vertical coordinate of a corresponding cell of the node based on the rank and the row height, determining the horizontal indent size of the cell based on the hierarchy information, and then determining a horizontal coordinate based on the horizontal indent size, where the horizontal coordinate and the vertical coordinate form the location information of the cell. After the location information of each cell is obtained, each instance data is rendered into the corresponding cell for display.

In some embodiments, when the cell is the column cell, the indentation information indicates a vertical indent size and a column width needs to be configured for the column cell. The process of determining, based on the hierarchy information, location information of a cell in which the instance data of each node is located may involve: first determining the rank of the instance data of the node based on the hierarchy information, determining a horizontal coordinate of a corresponding cell of the node based on the rank and the column width, determining the vertical indent size of the cell based on the hierarchy information, and then determining a vertical coordinate based on the vertical indent size, where the horizontal coordinate and the vertical coordinate process the location information of the cell. After the location information of each cell is obtained, each instance data is rendered into the corresponding cell for display.

Exemplarily, FIG. 5 is an example diagram of presenting instance data in an embodiment of the present disclosure. As shown in FIG. 5, it is a schematic diagram of presenting corresponding instance data in FIG. 3a and FIG. 3b. As shown in FIG. 5, the target instance data is indented differently according to different levels, such that the instance data is displayed with a hierarchical relationship.

In this embodiment, the instance data of each node is displayed as the list based on the hierarchy information, which allows for a match between the displayed instance data and a topology structure, thereby increasing the diversity in data presentation.

In the technical solution of the embodiments of the present disclosure, the target business object topology diagram configured by the user is received, where the target business object topology diagram includes the target business objects at the plurality of levels; the target instance data relationship information corresponding to the target business object topology diagram is determined, where the target instance data relationship information includes the target instance data corresponding to the target business object topology diagram and the association relationship between the target instance data; the instance data topology diagram is generated based on the target instance data relationship information; and the instance data topology diagram is displayed. According to the data processing method disclosed in the embodiments of the present disclosure, the corresponding instance data topology diagram is generated based on the target business object topology diagram configured by the user, and is then displayed, such that only instance data required by the user is presented. This can not only significantly reduce the amount of data to be processed, but can also increase the diversity and flexibility in data presentation.

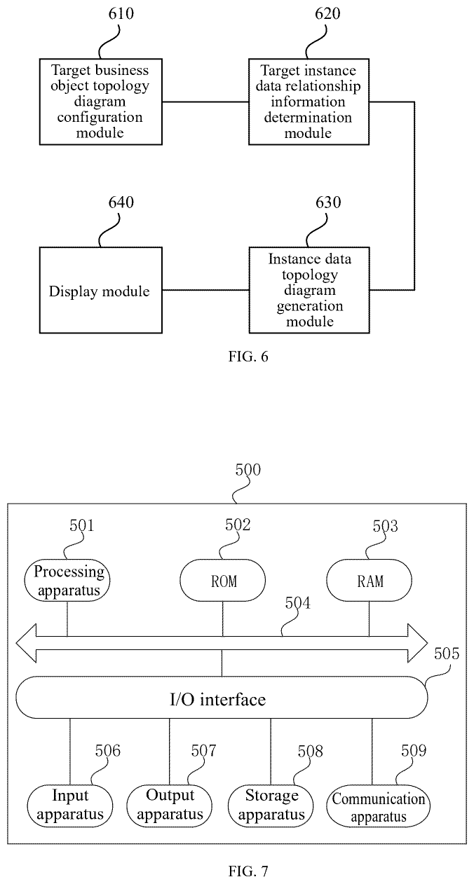

FIG. 6 is a schematic diagram of a structure of a data processing apparatus according to an embodiment of the present disclosure. As shown in FIG. 6, the apparatus includes:
a target business object topology diagram configuration module 610 configured to receive a target business object topology diagram configured by a user, where the target business object topology diagram includes target business objects at a plurality of levels;
a target instance data relationship information determination module 620 configured to determine target instance data relationship information corresponding to the target business object topology diagram, where the target instance data relationship information includes target instance data corresponding to the target business object topology diagram and an association relationship between the target instance data;
an instance data topology diagram generation module 630 configured to generate an instance data topology diagram based on the target instance data relationship information; and
a display module 640 configured to display the instance data topology diagram.

Optionally, the target business object topology diagram configuration module 610 is further configured to:
jump to a configuration page corresponding to a selected target business object based on a configuration operation triggered by the user on the selected target business object; and
receive a selection operation by the user on the configuration page for sub-target business objects to which the selected target business object expands on at least one level, to obtain a target business object topology diagram with the target business object as a root node.

Optionally, the target instance data relationship information determination module 620 is further configured to:
obtain original instance data relationship information corresponding to an original business object set; and
filter the original instance data relationship information based on the target business object topology diagram, to obtain the target instance data relationship information.

Optionally, the target instance data relationship information determination module 620 is further configured to:
traverse the target business object topology diagram to obtain a plurality of pieces of candidate instance data corresponding to a target business object that is traversed;
obtain target instance data of a parent node of the traversed target business object;
filter the plurality of pieces of candidate instance data to obtain candidate instance data that has an association relationship with the target instance data of the parent node, and determine the obtained candidate instance data as target instance data of the traversed target business object; and
record an association relationship corresponding to the target instance data and hierarchy information of the target instance data, where the hierarchy information is information about a level at which a target business object corresponding to the target instance data is located.

Optionally, the apparatus further includes a filtering module configured to:
obtain a filtering condition that is configured by the user for the traversed target business object; and
perform further filtering on the target instance data based on the filtering condition.

Optionally, the instance data topology diagram generation module 630 is further configured to:
group the target instance data based on the association relationship;
sort the grouped target instance data according to the hierarchy information; and
topologically connect the sorted target instance data to generate an instance data topology diagram corresponding to each group.

Optionally, the apparatus further includes an instance data topology diagram pruning module configured to:
obtain permission information of the user; and
prune the instance data topology diagram based on the permission information, to obtain a final instance data topology diagram.

Optionally, the display module 640 is further configured to:
obtain instance data and hierarchy information of each node in the instance data topology diagram; and
display the instance data of each node as a list based on the hierarchy information.

Optionally, the display module 640 is further configured to:
determine, based on the hierarchy information, location information of a cell in which the instance data of each node is located, where the cell is a column cell or a row cell, and the location information includes indentation information; and
display the instance data of each node as a list based on the location information.

The data processing apparatus provided in this embodiment of the present disclosure can perform the data processing method provided in any one of the embodiments of the present disclosure, and has corresponding functional modules and beneficial effects for performing the method.

It is worth noting that the units and modules included in the above apparatus are obtained through division merely according to functional logic, but are not limited to the above division, as long as corresponding functions can be implemented. In addition, specific names of the functional units are merely used for mutual distinguishing, and are not used to limit the scope of protection of the embodiments of the present disclosure.

FIG. 7 is a schematic diagram of a structure of an electronic device according to an embodiment of the present disclosure. Referring to FIG. 7 below, it is a schematic diagram of a structure of an electronic device (such as a terminal device or a server in FIG. 7) 500 suitable for implementing an embodiment of the present disclosure. The terminal device in this embodiment of the present disclosure may include, but is not limited to, mobile terminals such as a mobile phone, a notebook computer, a digital broadcast receiver, a personal digital assistant (PDA), a tablet computer (PAD), a portable multimedia player (PMP), and a vehicle-mounted terminal (such as a vehicle navigation terminal), and fixed terminals such as a digital TV and a desktop computer. The electronic device shown in FIG. 7 is merely an example, and shall not impose any limitation on the function and scope of use of the embodiments of the present disclosure.

As shown in FIG. 7, the electronic device 500 may include a processing apparatus (for example, a central processor and a graphics processor) 501 that may perform a variety of appropriate actions and processing in accordance with a program stored in a read-only memory (ROM) 502 or a program loaded from a storage apparatus 508 into a random access memory (RAM) 503. The RAM 503 further stores various programs and data required for the operation of the electronic device 500. The processing apparatus 501, the ROM 502, and the RAM 503 are connected to one another through a bus 504. An input/output (I/O) interface 505 is also connected to the bus 504.

Generally, the following apparatuses may be connected to the I/O interface 505: an input apparatus 506 including, for example, a touchscreen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a tape and a hard disk; and a communication apparatus 509. The communication apparatus 509 may allow the electronic device 500 to perform wireless or wired communication with other devices to exchange data. Although FIG. 7 shows the electronic device 500 having various apparatuses, it should be understood that it is not required to implement or have all of the shown apparatuses. It may be an alternative to implement or have more or fewer apparatuses.

In particular, according to an embodiment of the present disclosure, the process described above with reference to the flowchart may be implemented as a computer software program. For example, this embodiment of the present disclosure includes a computer program product, which includes a computer program carried on a non-transitory computer-readable medium, where the computer program includes program code for performing the method shown in the flowchart. In such an embodiment, the computer program may be downloaded and installed from a network through the communication apparatus 509, installed from the storage apparatus 508, or installed from the ROM 502. When the computer program is executed by the processing apparatus 501, the above-mentioned functions defined in the method of the embodiment of the present disclosure are performed.

The names of messages or information exchanged between a plurality of apparatuses in the implementations of the present disclosure are used for illustrative purposes only, and are not used to limit the scope of these messages or information.

The electronic device according to this embodiment of the present disclosure and the data processing method according to the above embodiments belong to the same inventive concept. For the technical details not exhaustively described in this embodiment, reference may be made to the above embodiments, and this embodiment and the above embodiments have the same beneficial effects.

An embodiment of the present disclosure provides a computer storage medium having stored thereon a computer program that, when executed by a processor, causes the data processing method according to the above embodiments to be implemented.

It should be noted that the above computer-readable medium described in the present disclosure may be a computer-readable signal medium, a computer-readable storage medium, or any combination thereof. The computer-readable storage medium may be, for example but not limited to, electric, magnetic, optical, electromagnetic, infrared, or semiconductor systems, apparatuses, or devices, or any combination thereof. More specific examples of the computer-readable storage medium may include, but are not limited to: an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may further be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server may communicate using any currently known or future-developed network protocol such as the hypertext transfer protocol (HTTP), and may be connected to digital data communication (for example, a communication network) in any form or medium. Examples of the communication network include a local area network (“LAN”), a wide area network (“WAN”), an internetwork (e.g., the Internet), a peer-to-peer network (e.g., an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: receive a target business object topology diagram configured by a user, where the target business object topology diagram includes target business objects at a plurality of levels; determine target instance data relationship information corresponding to the target business object topology diagram, where the target instance data relationship information includes target instance data corresponding to the target business object topology diagram and an association relationship between the target instance data; generate an instance data topology diagram based on the target instance data relationship information; and display the instance data topology diagram.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the case of the remote computer, the remote computer may be connected to the computer of the user through any kind of network, including a local area network (LAN) or a wide area network (WAN), or may be connected to an external computer (for example, connected through the Internet with the aid of an Internet service provider).

The flowchart and block diagram in the accompanying drawings illustrate the possibly implemented architecture, functions, and operations of the system, method, and computer program product according to various embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by software, or may be implemented by hardware. Names of the units do not constitute a limitation on the units themselves in some cases.

The functions described herein above may be performed at least partially by one or more hardware logic components. For example, without limitation, exemplary types of hardware logic components that may be used include: a field-programmable gate array (FPGA), an application-specific integrated circuit (ASIC), an application specific standard product (ASSP), a system on chip (SOC), a complex programmable logic device (CPLD), and the like.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

According to one or more embodiments of the present disclosure, a data processing method is provided. The method includes:
receiving a target business object topology diagram configured by a user, where the target business object topology diagram includes target business objects at a plurality of levels;
determining target instance data relationship information corresponding to the target business object topology diagram, where the target instance data relationship information includes target instance data corresponding to the target business object topology diagram and an association relationship between the target instance data;
generating an instance data topology diagram based on the target instance data relationship information; and
displaying the instance data topology diagram.

Further, the receiving a target business object topology diagram configured by a user includes:
jumping to a configuration page corresponding to a selected target business object based on a configuration operation triggered by the user on the selected target business object; and
receiving a selection operation by the user on the configuration page for sub-target business objects to which the selected target business object expands on at least one level, to obtain a target business object topology diagram with the target business object as a root node.

Further, the determining target instance data relationship information corresponding to the target business object topology diagram includes:
obtaining original instance data relationship information corresponding to an original business object set; and
filtering the original instance data relationship information based on the target business object topology diagram, to obtain the target instance data relationship information.

Further, the filtering the original instance data relationship information based on the target business object topology diagram, to obtain the target instance data relationship information includes:
traversing the target business object topology diagram to obtain a plurality of pieces of candidate instance data corresponding to a target business object that is traversed;
obtaining target instance data of a parent node of the traversed target business object;
filtering the plurality of pieces of candidate instance data to obtain candidate instance data that has an association relationship with the target instance data of the parent node, and determining the obtained candidate instance data as target instance data of the traversed target business object; and
recording an association relationship corresponding to the target instance data and hierarchy information of the target instance data, where the hierarchy information is information about a level at which a target business object corresponding to the target instance data is located.

Further, after the filtering the plurality of pieces of candidate instance data to obtain candidate instance data that has an association relationship with the target instance data of the parent node, the method further includes:
obtaining a filtering condition that is configured by the user for the traversed target business object; and
performing further filtering on the target instance data based on the filtering condition.

Further, the generating an instance data topology diagram based on the target instance data relationship information includes:
grouping the target instance data based on the association relationship;
sorting the grouped target instance data according to the hierarchy information; and
topologically connecting the sorted target instance data to generate an instance data topology diagram corresponding to each group.

Further, after the generating an instance data topology diagram based on the target instance data relationship information, the method further includes:
obtaining permission information of the user; and
pruning the instance data topology diagram based on the permission information, to obtain a final instance data topology diagram.

Further, the displaying the instance data topology diagram includes:
obtaining instance data and hierarchy information of each node in the instance data topology diagram; and
displaying the instance data of each node as a list based on the hierarchy information.

Further, the displaying the instance data of each node as a list based on the hierarchy information includes:
determining, based on the hierarchy information, location information of a cell in which the instance data of each node is located, where the cell is a column cell or a row cell, and the location information includes indentation information; and
displaying the instance data of each node as a list based on the location information.

The foregoing descriptions are merely preferred embodiments of the present disclosure and explanations of the applied technical principles. Those skilled in the art should understand that the scope of disclosure involved in the present disclosure is not limited to the technical solutions formed by specific combinations of the foregoing technical features, and shall also cover other technical solutions formed by any combination of the foregoing technical features or equivalent features thereof without departing from the foregoing concept of disclosure. For example, a technical solution formed by a replacement of the foregoing features with technical features with similar functions disclosed in the present disclosure (but not limited thereto) also falls within the scope of the present disclosure.

In addition, although the various operations are depicted in a specific order, it should not be construed as requiring these operations to be performed in the specific order shown or in a sequential order. Under certain circumstances, multitasking and parallel processing may be advantageous. Similarly, although several specific implementation details are included in the foregoing discussions, these details should not be construed as limiting the scope of the present disclosure. Some features that are described in the context of separate embodiments can also be implemented in combination in a single embodiment. In contrast, various features described in the context of a single embodiment may alternatively be implemented in a plurality of embodiments individually or in any suitable subcombination.

Although the subject matter has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

1. A data processing method, comprising:
receiving a target business object topology diagram configured by a user, wherein the target business object topology diagram comprises target business objects at a plurality of levels;
determining target instance data relationship information corresponding to the target business object topology diagram, wherein the target instance data relationship information comprises target instance data corresponding to the target business object topology diagram and an association relationship between the target instance data;
generating an instance data topology diagram based on the target instance data relationship information; and
displaying the instance data topology diagram.

2. The method according to claim 1, wherein the receiving a target business object topology diagram configured by a user comprises:
jumping to a configuration page corresponding to a selected target business object based on a configuration operation triggered by the user on the selected target business object; and
receiving a selection operation performed by the user on the configuration page for sub-target business objects to which the selected target business object expands on at least one level, to obtain a target business object topology diagram with the selected target business object as a root node.

3. The method according to claim 1, wherein the determining target instance data relationship information corresponding to the target business object topology diagram comprises:
obtaining original instance data relationship information corresponding to an original business object set; and
filtering the original instance data relationship information based on the target business object topology diagram, to obtain the target instance data relationship information.

4. The method according to claim 3, wherein the filtering the original instance data relationship information based on the target business object topology diagram, to obtain the target instance data relationship information comprises:
traversing the target business object topology diagram to obtain a plurality of pieces of candidate instance data corresponding to a target business object that is traversed;
obtaining target instance data of a parent node of the traversed target business object;
filtering the plurality of pieces of candidate instance data to obtain candidate instance data that has an association relationship with the target instance data of the parent node, and determining the obtained candidate instance data as target instance data of the traversed target business object; and
recording an association relationship corresponding to the target instance data and hierarchy information of the target instance data, wherein the hierarchy information is information about a level at which a target business object corresponding to the target instance data is located.

5. The method according to claim 4, wherein after the filtering the plurality of pieces of candidate instance data to obtain candidate instance data that has an association relationship with the target instance data of the parent node, the method further comprises:
obtaining a filtering condition that is configured by the user for the traversed target business object; and
performing further filtering on the target instance data based on the filtering condition.

6. The method according to claim 4, wherein the generating an instance data topology diagram based on the target instance data relationship information comprises:
grouping the target instance data based on the association relationship;
sorting the grouped target instance data according to the hierarchy information; and
topologically connecting the sorted target instance data to generate an instance data topology diagram corresponding to each group.

7. The method according to claim 1, wherein after the generating an instance data topology diagram based on the target instance data relationship information, the method further comprises:
obtaining permission information of the user; and
pruning the instance data topology diagram based on the permission information, to obtain a final instance data topology diagram.

8. The method according to claim 1, wherein the displaying the instance data topology diagram comprises:
obtaining instance data and hierarchy information of each node in the instance data topology diagram; and
displaying the instance data of each node as a list based on the hierarchy information.

9. The method according to claim 8, wherein the displaying the instance data of each node as a list based on the hierarchy information comprises:
determining, based on the hierarchy information, location information of a cell in which the instance data of each node is located, wherein the cell is a column cell or a row cell, and the location information comprises indentation information; and
displaying the instance data of each node as a list based on the location information.

10. (canceled)

11. An electronic device, comprising:
one or more processors; and
a storage apparatus configured to store one or more programs, wherein
the one or more programs, when executed by the one or more processors, cause the one or more processors to implement the data processing method comprising:
receiving a target business object topology diagram configured by a user, wherein the target business object topology diagram comprises target business objects at a plurality of levels;
determining target instance data relationship information corresponding to the target business object topology diagram, wherein the target instance data relationship information comprises target instance data corresponding to the target business object topology diagram and an association relationship between the target instance data;
generating an instance data topology diagram based on the target instance data relationship information; and
displaying the instance data topology diagram.

12. A non-transitory storage medium comprising computer-executable instructions, wherein the computer-executable instructions, when executed by a computer processor, cause the computer processor to perform the data processing method comprising:
receiving a target business object topology diagram configured by a user, wherein the target business object topology diagram comprises target business objects at a plurality of levels;
determining target instance data relationship information corresponding to the target business object topology diagram, wherein the target instance data relationship information comprises target instance data corresponding to the target business object topology diagram and an association relationship between the target instance data;
generating an instance data topology diagram based on the target instance data relationship information; and
displaying the instance data topology diagram.

13. The electronic device according to claim 11, wherein the receiving a target business object topology diagram configured by a user comprises:
jumping to a configuration page corresponding to a selected target business object based on a configuration operation triggered by the user on the selected target business object; and
receiving a selection operation performed by the user on the configuration page for sub-target business objects to which the selected target business object expands on at least one level, to obtain a target business object topology diagram with the selected target business object as a root node.

14. The electronic device according to claim 11, wherein the determining target instance data relationship information corresponding to the target business object topology diagram comprises:
obtaining original instance data relationship information corresponding to an original business object set; and
filtering the original instance data relationship information based on the target business object topology diagram, to obtain the target instance data relationship information.

15. The electronic device according to claim 14, wherein the filtering the original instance data relationship information based on the target business object topology diagram, to obtain the target instance data relationship information comprises:
traversing the target business object topology diagram to obtain a plurality of pieces of candidate instance data corresponding to a target business object that is traversed;
obtaining target instance data of a parent node of the traversed target business object;
filtering the plurality of pieces of candidate instance data to obtain candidate instance data that has an association relationship with the target instance data of the parent node, and determining the obtained candidate instance data as target instance data of the traversed target business object; and
recording an association relationship corresponding to the target instance data and hierarchy information of the target instance data, wherein the hierarchy information is information about a level at which a target business object corresponding to the target instance data is located.

16. The electronic device according to claim 15, wherein after the filtering the plurality of pieces of candidate instance data to obtain candidate instance data that has an association relationship with the target instance data of the parent node, the data processing method further comprises:
obtaining a filtering condition that is configured by the user for the traversed target business object; and
performing further filtering on the target instance data based on the filtering condition.

17. The electronic device according to claim 15, wherein the generating an instance data topology diagram based on the target instance data relationship information comprises:
grouping the target instance data based on the association relationship;
sorting the grouped target instance data according to the hierarchy information; and
topologically connecting the sorted target instance data to generate an instance data topology diagram corresponding to each group.

18. The non-transitory storage medium according to claim 12, wherein the receiving a target business object topology diagram configured by a user comprises:
jumping to a configuration page corresponding to a selected target business object based on a configuration operation triggered by the user on the selected target business object; and
receiving a selection operation performed by the user on the configuration page for sub-target business objects to which the selected target business object expands on at least one level, to obtain a target business object topology diagram with the selected target business object as a root node.

19. The non-transitory storage medium according to claim 12, wherein the determining target instance data relationship information corresponding to the target business object topology diagram comprises:
obtaining original instance data relationship information corresponding to an original business object set; and
filtering the original instance data relationship information based on the target business object topology diagram, to obtain the target instance data relationship information.

20. The non-transitory storage medium according to claim 19, wherein the filtering the original instance data relationship information based on the target business object topology diagram, to obtain the target instance data relationship information comprises:
traversing the target business object topology diagram to obtain a plurality of pieces of candidate instance data corresponding to a target business object that is traversed;
obtaining target instance data of a parent node of the traversed target business object;
filtering the plurality of pieces of candidate instance data to obtain candidate instance data that has an association relationship with the target instance data of the parent node, and determining the obtained candidate instance data as target instance data of the traversed target business object; and
recording an association relationship corresponding to the target instance data and hierarchy information of the target instance data, wherein the hierarchy information is information about a level at which a target business object corresponding to the target instance data is located.

21. The non-transitory storage medium according to claim 20, wherein after the filtering the plurality of pieces of candidate instance data to obtain candidate instance data that has an association relationship with the target instance data of the parent node, the data processing method further comprises:
obtaining a filtering condition that is configured by the user for the traversed target business object; and
performing further filtering on the target instance data based on the filtering condition.
